(19) United States
(12) Patent Application Publication
(10) Pub. No.: US 2019/0385429 A1
(43) Pub. Date: Dec. 19, 2019

(54) SYSTEMS AND METHODS OF SECURITY DEVICES FOR USE WITHIN A SECURITY PLATFORM

(71) Applicant: KOWLOON VENTURES LLC, Newport Beach, CA (US)

(72) Inventors: Vitalii Pochtar, Wysoka (PL); Yuri Vanetik, Orange, CA (US)

(21) Appl. No.: 16/012,703

(22) Filed: Jun. 19, 2018

(51) Int. Cl. G08B 13/26

(52) U.S. Cl. CPC G08B 13/26

(57) ABSTRACT

Embodiments of systems and methods related to security devices that can detect potential theft of valuable or important objects. In some embodiments, the security device can be embedded in or attached to an object of concern and provide notifications in relation to an unauthorized contact to the object (or contact to a container object including the object) and carrying away the object. When such unauthorized theft occurs, in some embodiments, the security device can provide a notification, such as a visual notification or auditory notification, or tactile notification.

### LIMITED COPYRIGHT AUTHORIZATION

A portion of the disclosure of this patent document includes material which is subject to copyright protection. The copyright owner has no objection to the facsimile reproduction by anyone of the patent document or the patent disclosure as it appears in the Patent and Trademark Office patent file or records, but otherwise reserves all copyrights whatsoever.

### BACKGROUND OF THE DISCLOSURE

This disclosure relates to a security system for detecting possible theft.

### SUMMARY OF EXAMPLE EMBODIMENTS

Various systems and methods for providing a security device for use within a security platform are disclosed. Embodiments of the systems and methods can detect a potentially unauthorized touch to a security device or an object the security device protects. In some embodiments, the security devices may additionally measure the distance between the security device and a user-known location such that the security device uses the detection of a touch and distance to enhance security. In some embodiments, a user may configure touch detection sensitivity and distance criteria. Embodiments of systems and methods related to generating a crime database of detected crimes, and accessing the database to inform a user of an existence of a crime-ridden area are also disclosed. Using the crime database, security mechanisms may alert a user of a crime-ridden area before the user ventures into the area, thereby preventing possible crimes.

The systems, methods, and devices of the disclosure each have several innovative aspects, no single one of which is solely responsible for the desirable attributes disclosed herein.

One embodiment discloses a security alarm device associated with a protected object. The security alarm device may include: one or more hardware processors; one or more output components; a proximity sensor in electronic communication with the one or more hardware processors and configured to provide to the one or more hardware processors a touch data signal indicative of a touch or near touch to a protected object; a communication component in electronic communication with the one or more hardware processors and configured to provide to the one or more hardware processors a distance data signal indicative of a distance between the communication component and a host computing device; and one or more storage devices configured to store software instructions configured for execution by the one or more hardware processors, wherein the software instructions cause the one or more hardware processors to: receive, from the proximity sensor, the touch data signal indicative of the touch to the protected object or the security alarm device, receive, from the communication component, the distance data signal indicative of a distance, based at least in part on the touch data signal and the distance data signal, one or more notification criteria have been met: and in response to determining the one or more notification criteria have been met, generate a notification data signal to one or more output components to provide a notification

Another embodiment discloses a computer-implemented method of detecting a potential security breach. The computer-implemented method may include, as implemented by one or more computing devices within a security alarm device configured with specific computer-executable instructions: receiving, from a proximity sensor within the security alarm device, a touch data signal indicative of a touch to a protected object or a security alarm device; receiving, from a communication component within the security alarm device, a distance data signal indicative of a distance between the communication component and a host computing device; based at least in part on the touch data signal and the distance data signal, determining that one or more notification criteria have been met; and in response to determining that the one or more notification criteria have been met, generating a notification data signal to one or more output components within the security alarm device to provide a potential security breach notification, where in the output component comprise one or more of a buzzer, a piezoelectric buzzer, or light emitting diode.

A further embodiment discloses a non-transitory computer storage having stored thereon a computer program. The computer program may include executable instructions that instruct a computer system to at least: receive, from a proximity sensor within a security alarm device, a touch data signal indicative of a touch to a protected object or a security alarm device; receive, from a communication component within the security alarm device, a distance data signal indicative of a distance between the communication component and a host computing device; based at least in part on the touch data signal and the distance data signal, determine that one or more notification criteria have been met; and in response to determining that the one or more notification criteria have been met, generate a notification data signal to one or more output components within the security alarm device to provide a potential security breach notification, where in the output component comprise one or more of a buzzer, a piezoelectric buzzer, or light emitting diode.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings. The accompanying drawings, which are incorporated in, and constitute a part of, this specification, illustrate embodiments of the disclosure.

Certain embodiments will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1A illustrates a schematic overview of an embodiment of a security device.

FIG. 1B illustrates another schematic overview of an embodiment of the security device.

FIG. 2A illustrates an example embodiment of a security device use scenario.

FIG. 2B illustrates example embodiments of data communications.

FIG. 3 illustrates example embodiments of security device configuration templates.

FIG. 4 illustrates an example embodiment of a security device state machine diagram.

FIG. 5 illustrates an example embodiment of a security device flowchart for touch and distance based theft detection.

FIG. 6 illustrates an example embodiment of a security server flowchart.

FIGS. 7A, 7B, 7C, and 7D illustrate example embodiments of graphical user interfaces on host devices.

FIG. 8 illustrates an example embodiment of a crime map generated from a crime database.

FIG. 9 illustrates an example embodiment of a system diagram of the security device.

### DETAILED DESCRIPTION OF VARIOUS EMBODIMENTS

Embodiments of the disclosure will now be described with reference to the accompanying figures. The terminology used in the description presented herein is not intended to be interpreted in any limited or restrictive manner, simply because it is being utilized in conjunction with a detailed description of embodiments of the disclosure. Furthermore, embodiments of the disclosure may include several novel features, no single one of which is solely responsible for its desirable attributes or which is essential to practicing the embodiments of the disclosure herein described. For purposes of this disclosure, certain aspects, advantages, and novel features of various embodiments are described herein.

This disclosure relates to embodiments of security devices that can detect stealing of valuable or important objects, thereby preventing or deterring possible thefts. The security devices can provide notifications of the detected thefts to a user. This disclosure also relates to usage of detected crimes for prevention and deterrence of such crimes as well as enforcement of crime control.

In some embodiments, the security device can be embedded in or attached to an object of concern and can provide notifications in relation to an unauthorized contact to the object (or contact to a container object including the object) or carrying away of the object. When such theft occurs, the security device can provide a notification (for example, an alarm text message). The notification may be a visual notification (for example, a light emitting diode (LED) flashing), or auditory notification (for example, piezoelectric buzzer buzzing), or tactile notification (for example, an actuator vibrating). Additionally, the security device may communicatively connect with a host device and cause the host device to utilize output interfaces of the host device to provide the notification (for example, amber alert text on a smart phone).

In some embodiments, the security device can include at least one proximity sensor that can detect a thief's touch, contact, or nearby presence (solely for the purpose of brevity, this disclosure will refer to the touch, contact, or presence as touch). The security device permits a user to adjust the proximity sensor's sensitivity level such that the detection of touch can be precisely adjusted to a desired sensitivity level suited for protection of an object of concern. As described, the object of concern may be an object or an object container, such as a wallet, purse, briefcase, bag, luggage, and so forth. The presence detection level can be adjusted such that it can reliably detect a touch to an object of concern or a container-type object of concern (such as a purse). In some embodiments, the security device may attach to a surface of an object of concern using adhesives or mechanical connections.

In some embodiments, the security device can include a distance measurement mechanism. For example, the security device may measure signal strength between the security device and a connected host device (for example, smart phone, tablet, wearable computer, and so forth) and associate the signal strength with a distance between the security device and the host device. In some embodiments, signal strength level can be used as a proxy of distance and thus not require a conversion into a distance unit. Solely for the purpose of brevity, this disclosure will refer to distance as including measured distance, signal strength, or other proxies of measured distance. When the distance meets distance criteria indicative of a theft, the security device can provide a notification to the host device. The host device may synchronously or asynchronously update the notification to a crime database.

In some embodiments, the security device can have a portable, insertable, or attachable shape or weight. In some embodiments, the security device may be a thin and small card-like device or a small widget. In some embodiments, the security device may have a shape similar to a credit card or a business card and may fit in a wallet's card holders. One or more parts of the security device can include adhesives applied for attachment to a surface of an object. In some embodiments, the security device may have one or more touch-sensitive section and touch-insensitive section, thus providing one or more touch-sensitive directions. The touch-sensitive side or direction may be configured to face toward or away from an object of concern.

### I. Example Schematic of the Security Device

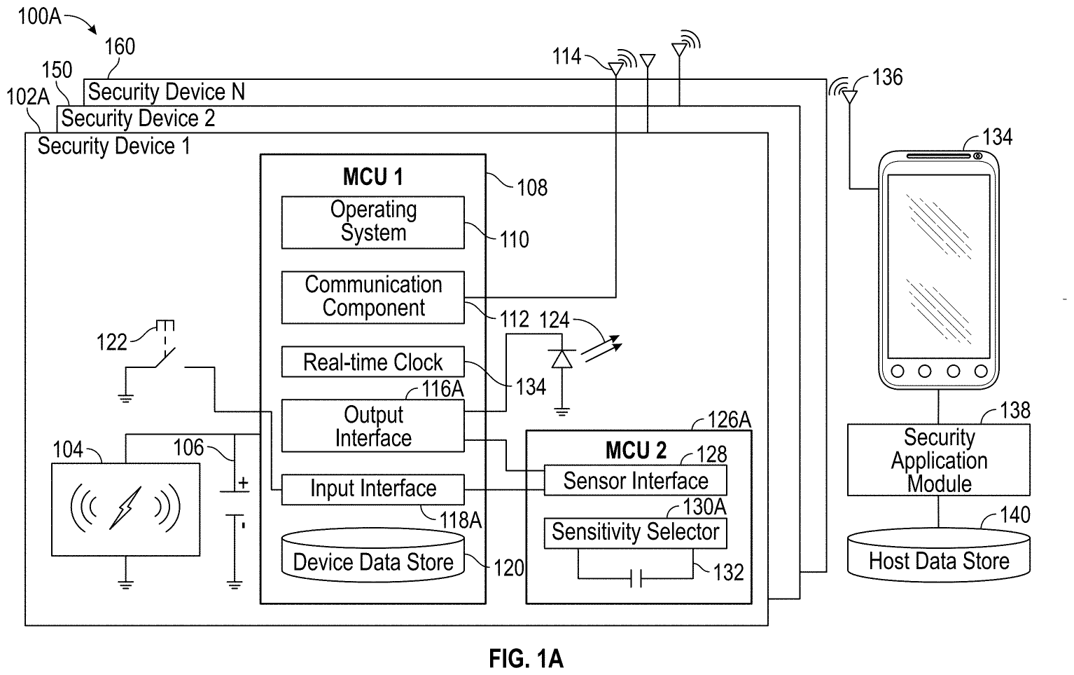

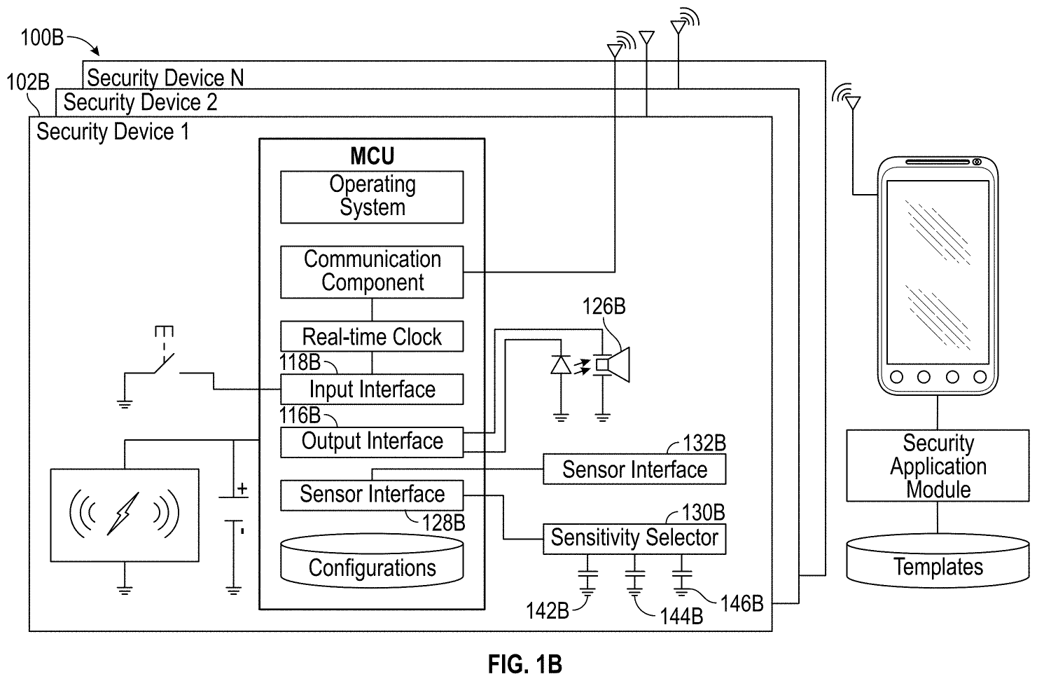

FIG. 1A illustrates a schematic overview 100A of an embodiment of a security device 102A. The security device 102A may include one or more microcontrollers, a power source 106, user input mechanisms (for example, a push button 122), indicators (for example, an LED 124), and an antenna 114. This security device embodiment 102A includes two microcontrollers, a device microcontroller 108 and proximity sensor microcontroller 126A.

Various types of power sources 106 can provide power to the security device 102A. For example, the power source may be an internal or local power source 106. Such internal or local power source 106 may be a rechargeable power source such as Lithium-Ion batteries or solar cells (for example, translucent film storing photovoltaic cells), or non-rechargeable including cylindrical batteries (for example, AA or AAA), or button cell batteries (for example, CR2032). In some embodiments, the security device 102A may draw electrical power from external sources of electrical energy, such as an external wireless power source 104 or a solar cell (not shown) may provide power to the security device 102A. Some embodiments may include more than one type of power source, such as a wireless charging circuit 104 for charging a local rechargeable battery and a rechargeable battery.

In the illustrated embodiment, the security device 102A includes a device microcontroller 108 and a proximity sensor microcontroller 126A. The device microcontroller 108 can include an operating system (OS) 110, communication component 112, real-time clock 134, output interface 116A for controlling various power and signal outputs, input interface for receiving various measurements and user inputs, a device data store 120, or other components. The device microcontroller 108 can supervise overall operation of the security device 102A including configuration and control, detection of touch, measurement of distance, and handling of the user inputs and outputs.

The communication component 112 may be in electronical communication with an antenna 114 for data transmission and reception. The device microcontroller 108 can utilize the communication component 112 and the antenna 114 to electronically communicate with a remote host device 134 using a defined communication protocol (for example, Bluetooth, Wi-Fi, NFC, RFID, and so forth). In some embodiments, the device microcontroller 108 may include a hardware or software communication stack implementing the defined communication protocol. The output interface 116A may electronically communicate with one or more output indicators (illustrated with an example LED 124). The input interface 118A can electronically communicate with one or more user inputs 122 (illustrated with an example tactile push button). The illustrated types of inputs and outputs are not to be limiting, and it is recognized that other types of inputs and outputs, such as a touch screen, can be a part of the security device 102A. The device microcontroller 108 may control the inputs and outputs with the input interface 118A and output interface 116A over its general-purpose input/output (GPIO) pins. Additionally, the device microcontroller 108 may utilize various digital and analog circuit components such as amplifiers or filters in interfacing with the various inputs and outputs. For example, the output interface 116A connected to an LED 124 can provide the LED 124 with an activation voltage. The device microcontroller 108 may also provide signal bus for communicating with other components. For example, the device microcontroller 108 may electronically communicate with the proximity sensor microcontroller 126A over a bus (for example, 120, SRI, UART, and so forth) by sending and receiving data packets between the two microcontrollers.

The illustrated security device 102A further includes the proximity sensor microcontroller 126A. The proximity sensor microcontroller 126A may include a sensor interface 128A, a sensitivity selector 130A, and at least one adjustable capacitor 132. The sensor interface 128A can receive, from the device system microcontroller 108, a desired touch detection sensitivity level. The proximity sensor microcontroller 126A may, based on the desired sensitivity level, configure or control the sensitivity selector 130A to adjust the one or more adjustable capacitor 132 according to the desired touch detection sensitivity level received.

The adjustable capacitor 132 may permit selection of many sensitivity levels. For example, an adjustable capacitor 132 with 8-bit configuration register may permit 254 levels of capacitance. Because the capacitance of the adjustable capacitor 132 relates to the touch detection sensitivity level, the proximity sensor microcontroller 126A can benefit from the high precision adjustments. When the adjustable capacitor 132 sensitivity setting is set to be insensitive, the registration of human presence by the sensor interface 128A can be limited to direct touches. On the other hand, when the adjustable capacitor 132 sensitivity setting is set to be highly sensitive, for example detecting distortions of electric field caused by further away human presence, the sensor interface 128A may register touches to a container object, such as touch to a purse that contains the security device 102A. Thus, the adjustable capacitor 132 can increase or decrease the touch detection distance.

In some embodiments, the sensor interface 128A may determine an existence of a touch (for example, from a detected disturbance in the electric field) and notify the device microcontroller 108 with an electronic indication of a touch. Thus, in some embodiments, the proximity sensor microcontroller 126A can be an integrated chip that specializes in touch detection. In some embodiments, the sensor interface 128A may provide the device microcontroller 108 of the raw measurements and delegate the determination of whether a touch has been detected to the device microcontroller 108.

The device microcontroller 108 may include a device data store 120. In some embodiments, the device data store 120 may be external to the device microcontroller 108, and the device microcontroller 108 may electronically communicate with the external data store. The device data store 120 may store a security device identifier, an operating system, device drivers, visual or auditory files for input or output (for example, notification sound file for a speaker output), communication stacks, device and sensor settings and configurations, or event logs.

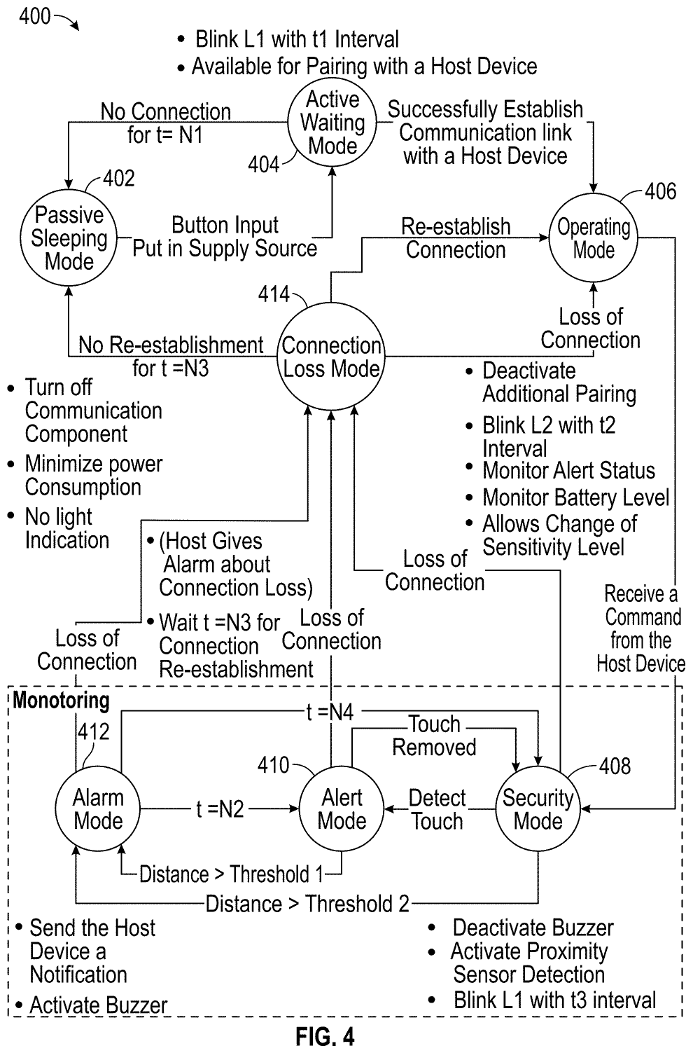

In some embodiments, the device microcontroller 108 may include a real-time clock 134. The real-time clock 134 can keep track of the current time and can be used by the device microcontroller 108 to provide a timestamp. For example, the device microcontroller 108 may access the real-time clock 134 to log a boot-up event or touch detection event. The device microcontroller 108 may also use the real-time clock 134 to set expiration time related to state transitions (further described with respect to FIG. 4) or for buzzer output duration.

It is recognized that the communication among the components of the security device may include the communication of data via various forms such as data packets or data signals and that such data packets or data signals may include one more pieces of data.

The security device 102A can communicatively couple with a host device 134 by establishing a communication session. Through each device's antennae 114 and 134, the two devices can wirelessly communicate. It is also recognized that a host device 134 may communicatively couple with more than one security device 102A. For example, the host device 134 may establish communication sessions with security devices 102A, 150, and 160 simultaneously.

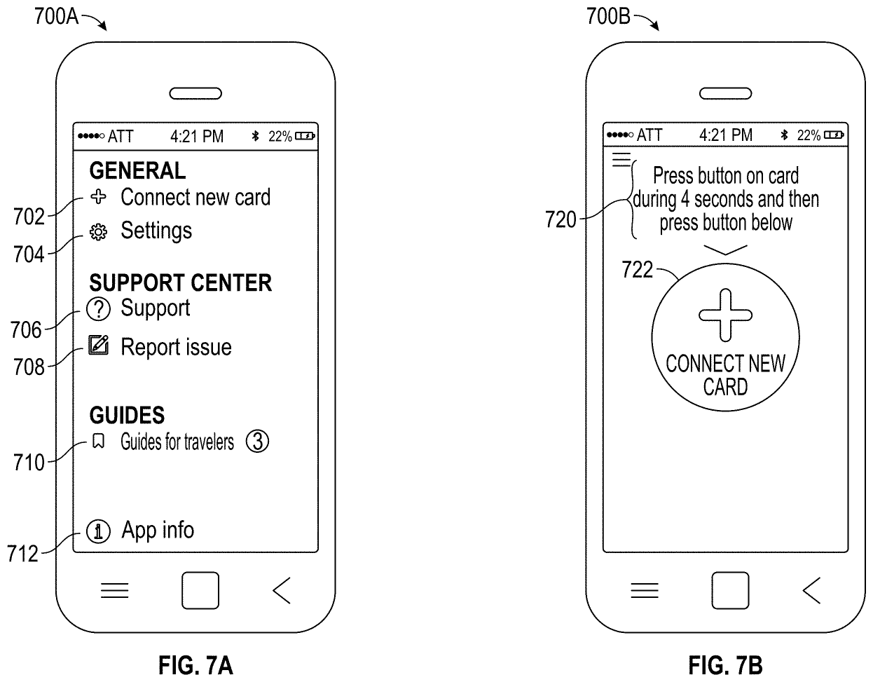

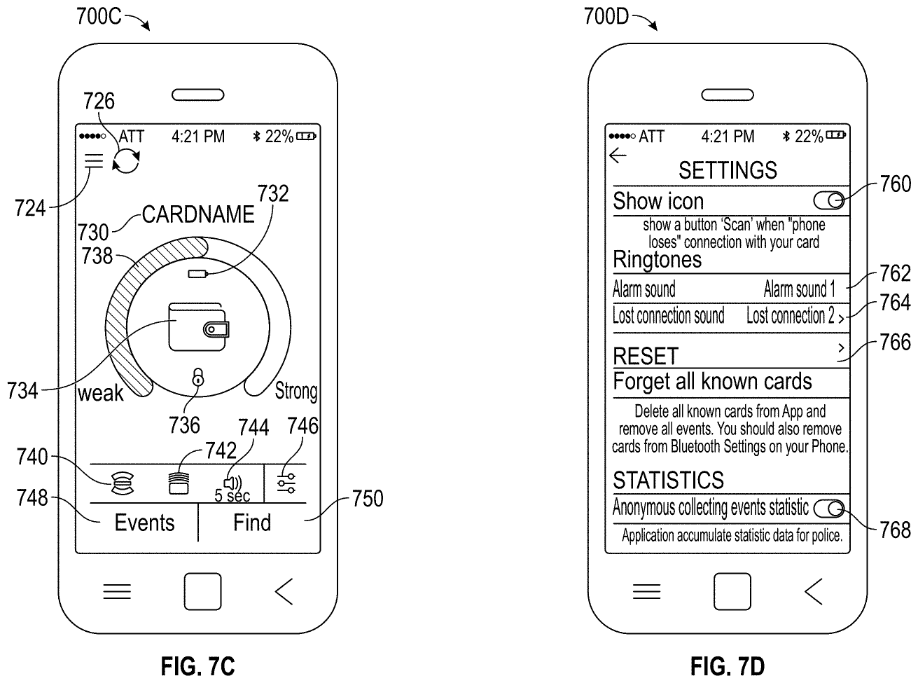

The host device 134 may include a security application module 138, which executes on the host device 134. The security application module 138 may receive data and commands from the security devices, for example commands regarding touch detection and distance measurements. Additionally, the security application module 138 may provide data and commands to the one or more security devices 102A, 150, 160 regarding configuration and control of the security devices. The security application module 138 can individually configure or control each connected security device or broadcast configuration and control to a set of security devices as a group. The security application module 138 can cause or send instructions for the host device 134 to display one or more graphical user interfaces on the display of the host device 134 (For example, FIGS. 7A-7D).

In some embodiments, the security application module 138 may store one or more templates 300 in a database. The database can be stored in a memory 140 on the host device 134 and/or a database on a server, such as a cloud server. The templates 300 may include default or custom settings associated with operating parameters (for example, a sensitivity setting or distance threshold) or presentation parameters (for example, font size or color scheme associated with the security application module 138). Such templates 300 can be loaded from the database by the security application module 138 and used to configure the one or more security devices 102A, 150, 160.

FIG. 1B illustrates another schematic overview 100B of another embodiment of the security device. In this embodiment, the proximity sensor is not an integrated chip (for example, a separate microcontroller 126A) but a combination of electrical components. For example, instead of the adjustable capacitor 132, a plurality of select capacitors 142B, 144B, 146B with static capacitance are present.

A sensitivity selector 130B can select one or more of the capacitors according to the capacitance selection instruction from a sensor interface 128B of the device microcontroller 108. The sensitivity selector 130B can be a digital selector or an analog selector, such as a digital or analog multiplexer. The security device may also include a proximity sensor 132B component that, based on the electric property measurements (for example, voltage, current, or phase) associated with the selected capacitor, compares the measured electric properties to touch detection criteria to determine whether the measurement is adequate to indicate a touch. In some embodiments, the proximity sensor 132B can be a separate circuit component outside the device microcontroller 108 (as shown) that informs indications of a touch to the device microcontroller 108. In some embodiments, the touch determination can be made on the device microcontroller 108 based on the raw electrical property measurement. Proximity sensor 132B on the device microcontroller 108 may be implemented as a software module, or as a hardware circuit or component.

While the example embodiments described capacitance-based proximity sensors, other types of proximity sensors that can be used to detect touch, such as proximity sensors based on optical, electromagnetic, Eddy-current, Doppler, magnetic, Hall-effect, or other properties may also be used for detection of “touch.”

The illustrated security device also includes another type of output indicator, a buzzer 126B. The buzzer 126B may be a mechanical, electromechanical, magnetic, electromagnetic, electro-acoustic, piezoelectric, or other type of buzzer. As described, the security device 102B can visually or auditorily indicate detection of a possible theft. The security device 102B may notify the possible theft to a user with one or more LEDs 124, buzzers 126B, speakers, and so forth. In some embodiments, a security device 102 may not include indicators in the security device 102B but delegate the notification of the possible theft to the host device 134 which can use host device 134 display or speakers to notify the user.

While the host device 134 was presented in a form of a mobile device, such as a smart phone, the host device 134 may be a tablet, laptop, a personal computer, smart watch, car console, or other types of computing devices.

### II. Example Use Scenario

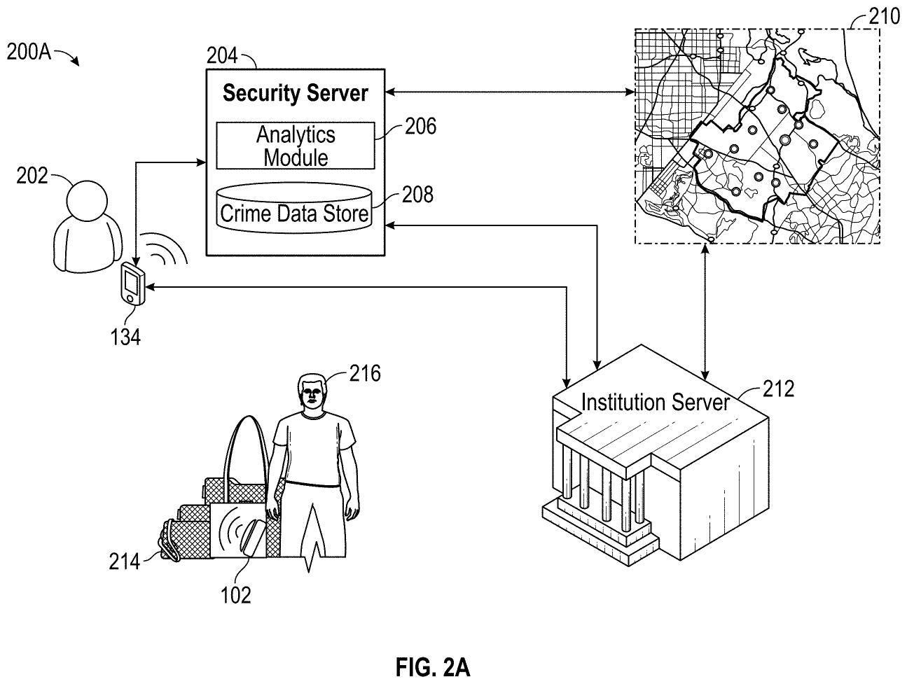

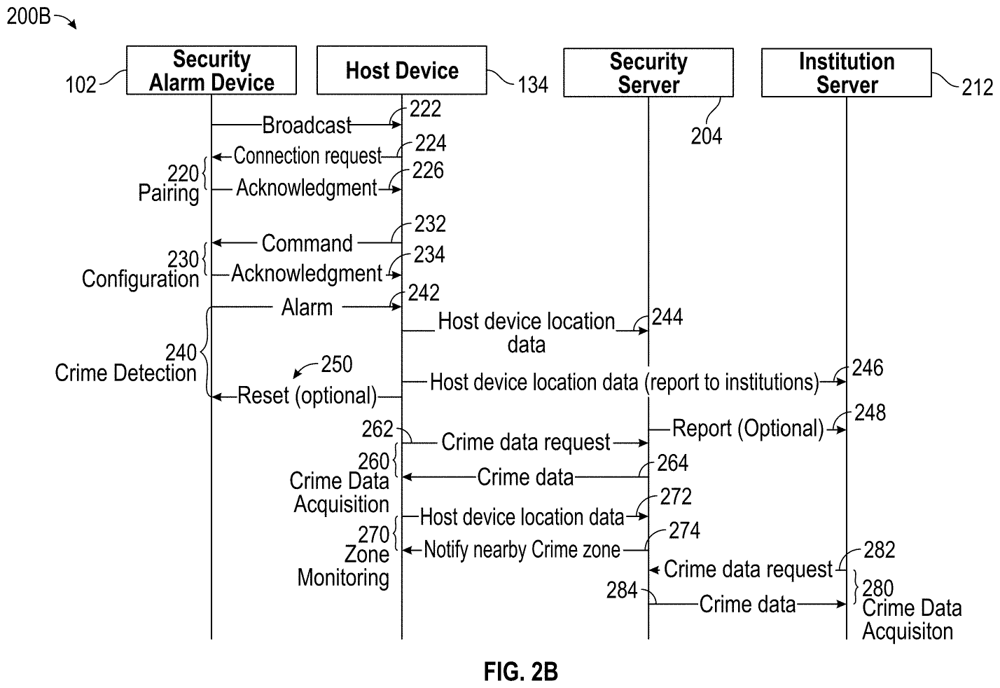

FIG. 2A illustrates an example security device use scenario 200A. The security devices can be attached to or embedded in an object. The security device utilizes proximity sensors to detect touch or nearby human presence such that the detection of possible theft improves upon existing systems in reliability and accuracy. The security devices can provide crime related data which various authorized entities may analyze to enhance prevention, deterrence, and enforcement for public.

Each person in today's society carries valuable belongings. Some of the belongings are highly valuable objects prone to theft. Additionally, some of the objects are of great importance (for example, cherished photographs or identification card) and losing the objects can be detrimental to the carrier. In some instances, an object could be a container that helps carry multitude of other objects of concern. For example, a wallet can contain cash, bank cards and credit cards, identifications, and photos of cherished ones all at once. Similarly, a bag may carry a wallet, car key, and house key.

The objects of importance or value may be lost due to the person's inattention or due to a malignant perpetrator, such as a thief. Enhancing the security of the object can prevent the distressful loss. Additionally, if the innocent carrier can become aware of a likelihood of theft beforehand, the carrier may actively prevent theft.

Thus, security devices and method which can accurately and reliably detect a loss of an object is desired. The desired security devices should be easy to configure and control, and can readily be used in association with the objects. Additionally, means for notifying a person of crime-ridden areas can be helpful in preventing and deterring crimes as well as enforcing crime control. Thus, identification of crime-ridden areas is desired.

In this scenario, a user 202 is the owner of a host device 134, security device 102, and an object of concern 214 (for example, a valuable or important object). Here, the object of concern 214 is a purse, and the user 202 has attached or embedded the security device 102 on or in the object 214.

In operation, the illustrated security device 102 and the host device 134 are configured to report detection of suspicious activities. The user 202 has established electronic communication between the security device 102 and the host device 134, via their respective antennae 114, 136. As described in relation to FIGS. 1A and 1B, the security device 102 can detect a touch and a separation distance between the security device 102 and the host device 134.

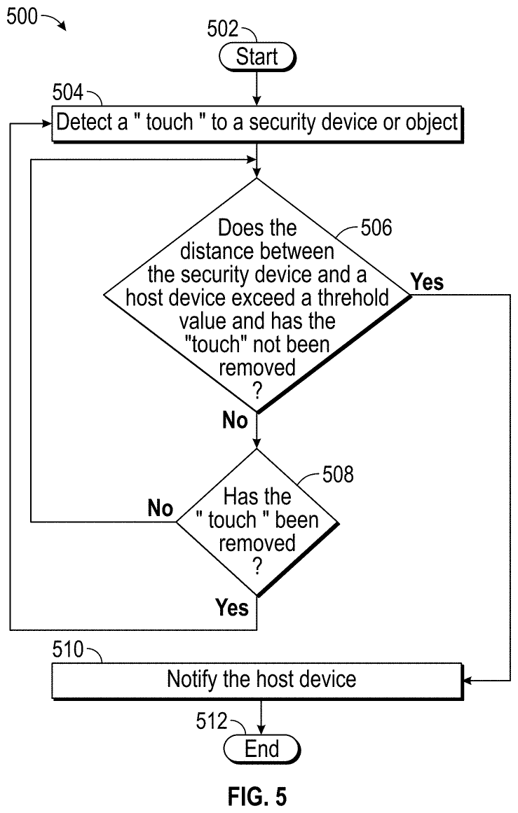

If a person 216 snatches an object of concern, such as the purse 214, the security device 102 is configured to detect the person's touch to the purse 214. As will be described further in detail with respect to FIG. 5, the security device 102 registers the person's touch. In some embodiments, the security device 102 provides a notification of the touch to the host device 134. As the person 216 carries away the purse 214, the distance between the security device 102 and the host device 134 increases. FIGS. 1A and 1B describe embodiments for establishing electronic communication between the security device 102 and the host device 134. The distance can be calculated based on, for example, signal strength of the established communication. Stronger signal strength may indicate a closer distance while weaker signal strength may indicate a further distance. In some embodiments, a loss of signal within some time duration of a detected touch can also indicate a possible theft. The distance is monitored by the host device 134, security device 102, or both and when one or more distance criteria (for example, distance threshold of, say, 5 meters) is met, the host device 134 is notified of a possible theft. As will be described in further detail, the touch detection and the distance criteria may be configured as the user deems appropriate in relation to the level and type of security desired. The user may have one or more predefined configuration settings, such as configuration templates 300, for an easy, quick, and automatic configuration of the security device 102. For example, the touch detection and distance may be different for a credit card, since a normal use may involve the credit card be taken away by a person (for example, a waiter at a restaurant to pay the bill). In such a scenario, the distance may be set to a larger distance than that for a purse, and/or the security feature may be temporarily disabled while the bill is being paid.

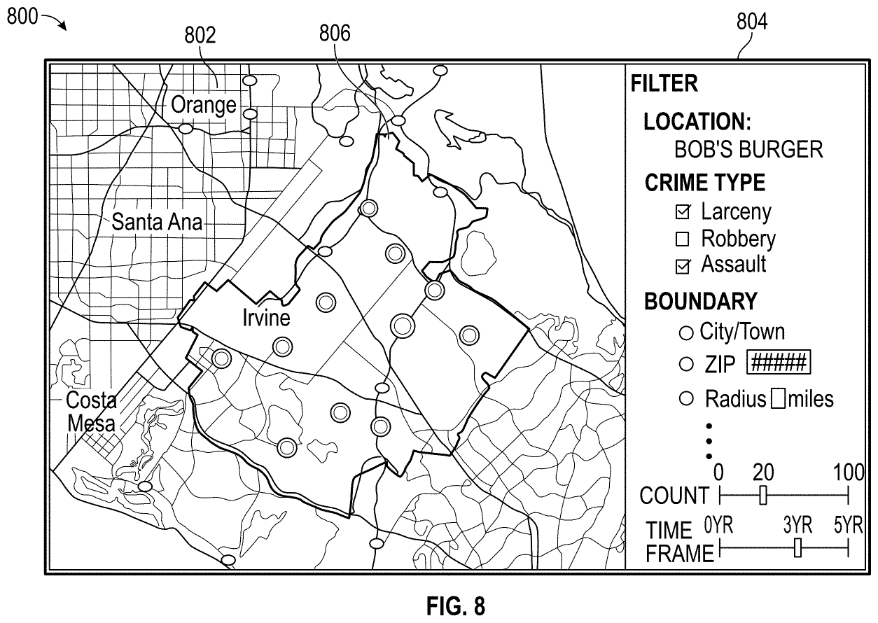

When the host device 134 receives a possible theft notification, the host device 134 may generate and send an electronic data packet indicating a possible theft to a security server 204 or an institution server 212 (for example, a police server). The security server 204 may include an analytics module 206 and a crime data store 220. The electronic data packet notification may include data such as, for example, crime event identification information, location data, timestamp, source security device identification, source host device identification, user identifier, or other information associated with the theft. The security server 204 and the institution server 212, after receiving the electronic data packet, may parse the data packet to extract the stored data and then use the data to determine whether the crime event underlying the notification is a new crime event or an existing crime event. For example, the analytics module 206 may determine that the crime event is new, and may update the crime data store 220 with the relevant crime event information. If the crime event is an existing crime event in the crime data store 220, the analytics module 206 may store duplicate information or discard the notification. From the accrued crime events in the crime data store 220, the security server 204 or the institution server 212 may generate analytics about the crime data and also provide visualization tools that allow users to visually analyze and manipulate the data, such as a crime map 210. The crime map 210 may be generated by the security server 204 or generated by an external server (such as a cloud server). Further details on embodiment of a crime map will be described with respect to FIG. 8.

It is recognized that the institution server 212 may receive and aggregate information related to theft attempts directly from the host device 134 or from the security server 204. The institution may be a community watch group, or any authorized entity interested in crime-related information for deterrence and enforcement purposes. In some embodiments, the analytics module 206 may provide filtering mechanisms. For example, crime-related information may first be depersonalized (remove personally identifying information of the victims) by the host device 134 or the security server 204 before the information is provided to the institution server 212, or other filtering could be applied such as filtering by a day or hours, or by crime types for a more detailed representation of the past crimes and likelihood of future crimes. The institution may utilize the received crime-related information to increase the public awareness or to enhance public security. For example, when a theft event information is received by the police station server, the event information may be used to quickly dispatch patrol cars to the alleged crime location. Additionally, the crime map 210 generated by the security server 204 or the institution server 212 can readily inform the public of dangerous geographic areas.

### III. Example Data Communications

FIG. 2B illustrates embodiments of example data communications among a security device 102, a host device 134, a security server 204, and an institution server 212. Representative communication categories include paring 220, configuration 230, crime detection 240, crime data acquisition 260, and zone monitoring 270. The data communications in each of the categories are for illustrative purposes only and it is recognized that different categories may be used, and that each category may contain more or less data communication transactions. Additionally some of the data communications may be optional depending on the implementations of the various embodiments.

A. Pairing

Pairing 220 of the security device 102 and the host device 134 may begin with the security device 102 broadcasting 222 a notification to indicate its presence and readiness for pairing to one or more host devices 134. The broadcasting may allow the security device 102 to be discoverable by host devices 134, such as via Bluetooth pairing. The host device 134, when it detects a broadcasting security device 102, may transmit to the security device 102 a connection request 224. The security device 102, after receiving the connection request 224 from the host device 134, may then return an acknowledgment 226 and establish an active connection session using various communication protocols including, for example, Bluetooth, Wi-Fi, cellular, or other types of communication protocols. The pairing 220 may include exchanging of data including, for example, addresses, identifications, or encryption keys. In some embodiments, after the completion of the pairing 220, the security device 102 may be configured to conceal itself from being discoverable by other host devices, such that the security device 102 can be coupled with only one host device 134 at a time. On the other hand, a host device 134 may pair with a plurality of security devices 102, 150, 160, or multiple host devices 134 may pair with each security device 102, 150, 160. In some embodiments, the user may configure the settings of the host device such that the establishment of the connection session may generate paired device profiles in respective devices such that subsequent parings 220 are automatically completed without user intervention or commands. In some embodiments the established communication channel between the paired devices may utilize pseudo-random frequency hopping or other communication mechanisms to enhance security against undesired eavesdroppers.

B. Configuration

Configuration 230 may begin with the host device 134 transmitting a command 232 to the security device 102. Upon reception of the command, the security device 102 may respond with an acknowledgment 234 of the receipt of the command. A command 232 may relate to detection sensitivity, diagnostics, operational state change, or the like of the security device 102. For example, the host device 134 may send a command requesting increased distance criteria, thereby making it less likely to provide a false theft notification. After the security device 102 adjusts its distance criteria, it may send an acknowledgment 234 of the completion of the requested command 232 back to the host device 134. An example diagnostic command 232 may be the host device 134 transmitting a request for security device's 102 identification, to which the security device 102 may generate a data packet containing its identification and provide the identification within its acknowledgement 234 to the host device 134. Another example diagnostic may be periodic check of the security device's 102 remaining battery.

C. Crime Detection

In some embodiments, crime detection 240 communications are communications related to notifying associated devices or servers of a detected crime. Crime detection 230 communications may begin with the security device 102 sending to the host device 134 a notification 242 (for example, an alarm) when the security device 102 determines that the crime detection criteria have been met. As will be described further in detail in relation to FIG. 4, the notification criteria may be based on touch detection and/or the distance between the two devices. When the host device 134 receives the notification, the host device 134 may further notify the security server 204 or the institution server 212. The notification 244, 246 to the security server 204 or the institution server 212 may further include other identifying information such as the host device identifier, urgency related information, information related to specific time and location 244 as available to the host device 134, or other information. Such information may be encrypted to ensure that the information provided to the one or more servers is authentic. In some embodiments, the further notifications may also include environmental information such as that the host device 134 was in a concert zone. Optionally, the environmental information may be determined by the security server 204 or the institution server 212 based on the time and location of the host device 134. In some embodiments instead of the host device 134 notifying one or more institution servers 212, the security server 204 may instead provide notification 248 to the institution servers 212. The security device 102 may provide the notification 242 of a possible theft multiple times, repeating with the same or similar crime identifier embedded in the notification 242. Optionally, the host device 134 receiving the notification may provide to the security device 102 a reset signal acknowledging that it has received the notification and thus stopping the security device 102 from further repeating the notification 242.

D. Crime Data Acquisition

In some embodiments, crime data acquisition communications 260 are communications related to notifying the user of the host device 134 of a likelihood of a potential crime event. Crime data acquisition 260 communications may begin with the host device 134 sending to the security server 204 an electronic crime data request 262. The crime data request 262 may include, for example, location information related to the crime data, such as geographic locations that the user is interested in or a geographic location associated with the current location of the user or the host device. For example, a traveling user may want to access information on whether the neighborhood that the user is about to enter or plans to visit later that day has a high crime rate.

The security server 212 may extract the location information and apply any filtering criteria to access data within the crime events database, such as for example geographic location, relevant time period, types of crime categories, and so forth. Then, the security server 212 may analyze the crime events retrieved from the crime database 208 and generate instructions to provide some representation of the retrieved crime data 264 for viewing on the host device. The representation may take various types of formats such as an interactive graphical map display, a list of flagged crime factors, a file overlay to be displayed in conjunction with a third party application (such as, for example, an overlay for Google Maps or Waze), and so forth. The representation may include a variety of data, including, for example, crime count, crime rate per capita, crime rate per a given area, a warning level indication (for example, green for low, orange or moderate, red for high crime rates, or 1-10 scale with 1 being lowest crime probability and 10 being highest crime probability, a warning icon, and so forth).

In some embodiments, the institution server 212 may send a crime data request 282 for crime data 284 from the security server. For example, a crime enforcement agency such as the police department may send a crime data request 282 so that it can use the requested crime data 284 to plan police patrols. Such crime related data can be immensely helpful in enforcement of the law as well as in prevention and deterrence of the crimes. As another example, an insurance company may send a crime data request 282 to generate analytics on the safety of specific geographic areas or neighborhoods.

E. Zone Monitoring

In some embodiments, zone monitoring 270 communications are communications related to making aware the user of the host device 134 of nearby crime-ridden areas. The security application module 138 may periodically send to the security server of the location 272 associated with the host device, and the security server 204 may provide crime information associated with the geographic area of the host device 134. For example, a user traveling into a crime-ridden area can be immediately notified 274 of the dangerous nature of the area the user is about to enter or is currently in. In some embodiments, the user may configure the security application module 138 to subscribe to or unsubscribe from such notifications.

### IV. Configuration Templates

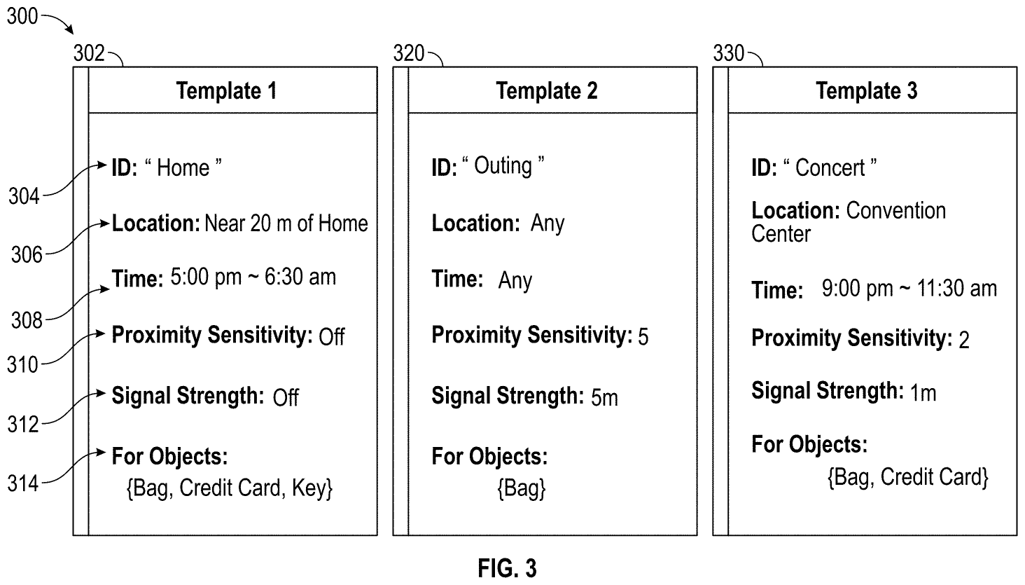

FIG. 3 illustrates example embodiments of security device configuration templates 300. While three example templates 302, 320, 330 are illustrated, it is recognized that any number of computing templates can be used by the security device. The illustrated templates provide example settings for varying scenarios.

A. Example Criteria

The example criteria include: an identifier field that provides a description of the environment in which the template will apply, a location field that captures information on one or more geographic data areas that are covered by the template, a time field that provide information on the time of day in which to apply the template, a proximity sensitivity field which provides the level at which the sensitivity is set, a signal strength field which indicates a signal strength level, as well as a for objects field which indicates categories or names of objects to which the template would apply. It is recognized that a variety of criteria may be used and that additional or different criteria may be used.

B. Template Selection

The host device may be configured such that the templates are applied automatically and/or when selected by a user. A template may be applied automatically when a connected host device 124 determines that specific criteria are met. After the criteria are met, the host device then sends configuration commands (see, for example, FIG. 2B, configuration 230) indicating the template's settings 310, 312, 314 to one or more of the connected the security devices 102, 150, 160. The settings information may include, for example, the proximity sensor sensitivity 310, distance criteria 312 for providing notification, or object categories 314 for which the settings should apply. As one example, a template may be automatically applied when the host device determines that a security object or host device is currently located within a geographic area of a specific template. The host device's location can be accessed or otherwise determined based on the host device's location module (for example, a GPS module). As another example, a template may be automatically applied when the time criteria of that template is currently being met. The security device 102 or the connected host device 134 may look up current time on a real-time clock to determine whether the time criteria 308 has been met. As a further example, a template may be automatically applied after two or more criteria have been met, such as, for example, both the location criteria 306 and the time criteria 308.

Another template may be applied when express instructions have been received from a user to apply a specific template to update the configurations of some or all of the connected security devices. The express instructions may be received after a user has indicated that specific template should apply via a selection in a graphical user interface or via a voice command. In some embodiments, the templates may be activated always automatically, always by express instructions, or some type of combination. For example, the host device may allow users to designate one or more of the templates to be activated automatically, one or more of the templates to be activated only by express selection, or based on rules that designate the priority order in which to apply specific templates.

C. Example Templates

Template 302 includes an ID 304 that indicates that the template relates to example settings for when the user is at home. In template 302, the settings are configured to be less sensitive than when the object is in a crowded public location to help reduce false alarms that may occur while in a safer home environment. Template 302 also indicates that the template is to be used when the host device is located within 20 meters of the user's home, where the user has designated a specific geographic location as the user's home, such as, for example, address or Global Positioning Satellite coordinates. The signal strength measurement may be used as a proxy for distance to determine whether the host device is located within 20 meters of the user's home. Template 302 also includes time criteria 308 of 5:00 pm to 6:30 am indicting the time of day in which the template could be active (assuming the other criteria are met). If the host device is configured to allow the Home template 302 to be automatically applied, the host device 134 may determine that the host device or one of the security objects is within 20 meters of the area designated as “home” and determine that current time is 7:15 pm. Because both criteria are met, the host device 134 may automatically send configuration instructions to connected security devices that are of the object types 314 “bag, credit card, or key”, turn off proximity sensitivity 310 and signal strength 312. Such sensitivities may be turned off to help avoid the possibility of false alarms (such as, a notification caused by the user's child who is playing with the credit card), and because the user is comfortable with turning off notifications at home. However, it is also recognized that, another user may not want such relaxed settings and may decide to reduce to a lower sensitivity level and increase the signal strength 312 to a greater detection distance, but still keep the sensors on to still received notifications (such as, a notification cause by the user's young adult child who may try and borrow the user's car key to take the car for a drive without permission).

Template 320 includes an ID of “Outing” indicating example criteria and settings that can be used for when the user goes on a casual outing. The location criteria and time criteria are set to “Any” indicating that, unless overridden, such as by another template, by rules, or manually by the user, the template's 320 settings can be applied broadly in most locations and at any time of the day. Template 320 is limited to specific object types of the type “bags.” The limited application of the template 320 may be beneficial in that when the user goes on a casual outing, most of his or her important belongings (for example, credit cards, keys, and so forth) may be stored within a bag. Also, because at an outing the user may put the credit card on a tab at a bar or provide a car key to valet parking personnel, the user may want to have such settings applied to cards to help reduce likelihood of inaccurate false alarms. However, another user who is continually leaving his credit card at restaurants, may decide to also apply this template to credit cards. Template 320 has settings of higher proximity sensitivity (sensitivity 5) and more moderate distance (5 meters). A higher proximity sensitivity setting may indicate a lower touch distance detection threshold (for example, 0-1 inches or 0.0-2.54 centimeters) whereas a lower sensitivity may indicate a higher touch distance detection threshold (for example, 10 inches or 25 centimeters). Having too high of a sensitivity may trigger a notification when there are merely people nearby (such as walking next to the security object or sitting next to the security object on a subway) and then end up providing false alarms. The settings or criteria in the template 320 may be beneficial to situations where the security device is being transported in public, but where people generally respect personal distance (thus, allowing for higher proximity sensitivity). In some embodiments, the user may modify one or more settings or criteria after application of a template, or adjust the template itself before the application of the template for enhanced security. It is recognized that various geographic regions have different expected distances between the security object and others such that the settings can be adjusted to account for such differences. For example, settings for a purse that will be carried by a user on a crowded Japanese subway may be different for settings for a running belt of a user who will be jogging along a quiet creek trail.

Template 330 includes an ID of “Concert” has associated examples settings that can be used for a concert-attending user. Template 330 defines location criteria and the time criteria as any, such that when a user arrives at the concert venue and knows the concert duration, the user may send an instruction to manually apply this template 330 right before the concert. Optionally, a host device 134 may automatically apply the template 330 to some or all of the security devices when the host device 134 detects current location to be convention center indicated by the Location field and time associated with the Time field. In some embodiments, the security application module 138 may, with user authorization, access a user's electronic calendar and retrieve the time and/or location details of the concert from the user's electronic calendar. For template 330, the proximity sensitivity is set lower (to 2) because the user may believe it is much more likely for another person to be close to the user at a concert than at an outing. The distance criteria is set to a much shorter distance (1 m) than at a general outing. The user may decide to have such shorter distance settings believing that if a thief snatches away an object of concern during a concert, it may be difficult to spot the thief if the thief gains 5 meters before the user receives a notification of the theft such that a notification after a shorter distance is preferred while the user is at the concert. Additionally, template 330 applies to a bank or credit card but not a car key. In a concert venue, the user may have planned to use the valet parking such that the car key will be a long distance from the host device and so it is not include in the category of objects for template 330.

D. Other Templates

The templates 302, 320, 330 are for examples only, and it is recognized that other implementations may include more or less settings and criteria. There is no limit to the number of available templates, and some templates may be preconfigured and provided as a default set of templates, which a user may customize. For example, the user may change “on/off” or degrees of sensitivity with respect to various features, such as, for example, touch detection, distance detection, or communication loss. Thus, a security device at home may be configured to have all sensitivities set to off such that the security device is considered fully “sleeping,” whereas a security device at work may be configured to turn off touch detection, but have a setting for communication loss.

In some embodiments, the security application module 138 may include instructions that allow the user to create, edit, deleted, and/or save templates. Further, in some embodiments, one or more default templates may be downloaded from a server (for example, institution server, cloud server, and so forth). Some of these templates may be provided by entities associated with a particular location, such as a shopping mall, or events, such as a concert, whereas other templates may be provided by other entities such as employers who provide employees with company credit cards, law enforcement agencies that provide employees with weapons, and so forth. In some embodiments, templates may access and use data from other sources such as event invites on a calendar, “home” setting on a driving application, and so forth. In some instances, the security application module 138 may inform or recommend to the user an available template for an environment or an occasion.

### V. State Machine Diagram

FIG. 4 illustrates an embodiment of an example security device state machine 400 for a security device. At state 402, the security device is in a Passive Sleeping Mode. In this mode, the communication component may turn off, thereby minimizing power consumption. The LEDs, buzzers, or other indicators may also be in an off state. From this Passive Sleeping Mode, the security device may transition to the Active Waiting Mode state 404. The transition may be triggered by an input received via a button or receiving a power source where the power source was previously not available. For example, a user may click on the tactile push button 122 to activate or otherwise wake up the security device from the passive sleeping mode into the active waiting mode.

At state 404, the security device is in the Active Waiting Mode, which may be referred to as a standby mode. In some implementations, an LED may blink with a t1 time interval so that there is a visual indication of the Active Waiting Mode. In this state 404, the security device may use a channel of a communication protocol to broadcast its presence and readiness to establish a communication session with a host device, such as an advertisement channel. The communication session may be established over some existing protocols such as Bluetooth or Wi-Fi, or like. The broadcast notification may be available for all host devices within the range of communication. In this state 404, the data communications, which can be similar to pairing 220 communications, may be transmitted and received to and from the security device and the host device to establish a communication session. After a communication session has been established successfully, the security device may transition into an Operating Mode state 406. In some embodiments, if no connection is established with any host device for a time duration N1, the device may transition back into the Passive Sleeping Mode.

At state 406, the security device is in the Operating Mode. In some embodiments, the security device may become unavailable for pairing with other host devices. For example if the communication session is established over a Bluetooth protocol (for example, Bluetooth 1.x, 2.x, 3.x, 4.x also known as Bluetooth low energy (LE), or the like), the security device, after it has been paired, removes itself from the advertisement or broadcast channel and enters into a mode of pseudorandom frequency jump and data encryption. In this state 406, a second LED may blink with the t2 time interval so that there is a visual indication of the Operating Mode. The security device can monitor alert status and remaining battery charge level, which the host device may access, for example, via the host device's security application module 138. Additionally, a user may, via the security application module 138, change the sensitivity of the proximity sensor, determine the distance between the security device and the host device, apply the templates, or otherwise communicate with the security device. In some embodiments, the host device may send a command to transition the security device from the Operating Mode into a Security Mode. The command may be based on user input or may be based on criteria which automatically triggers the sending of the command.

At state 408, the security device is in the Security Mode. In this mode, the proximity sensor 126A, 126B can be activated based on the provided settings. One or more output indicators may indicate that the security device is ready to detect any possible theft. For example, an LED may blink with the t3 time interval to indicate the state 408 so that there is a visual indication of the Security Mode. The touch and distance determinations may be used individually or in combination to generate signals that are used to determine a possible theft. The proximity sensor may register a touch or near touch to the security device or to an object to which the security is attached to or embedded, but where the distance between the security device and the host device is relatively short (for example, approximately 30 inches or 0.75 meters away indicating that the object is near the user). When a touch or near touch is registered that meets the provided settings, the security device may transition into an Alert Mode.

At block 410, the security device is in the Alert Mode such that the touch or near touch is registered (for example, from block 408) but a notification is not yet triggered. If the registered touch/near touch is then removed (for example, the security device no longer detects the touch or near touch), the security device may transition back into the Security Mode 408. If the touch or near touch remains registered, the security device measures the distance between the host device and the security device. In some embodiments, the distance between the two devices may be measured more precisely than would normally be measured in another state. For example, the security device in the Alert Mode may measure distance more accurately than in Security Mode. The security device compares the measured distance against distance criteria to determine whether its notification criteria have been met. For example, when the security device determines that the measured distance equals or exceeds a certain distance threshold (for example, threshold 1 in FIG. 4), the security device may transition into an Alarm Mode state 412.

In some embodiments, the security device may transition from the Security Mode directly into the Alarm Mode without the detection of the touch or near touch based on the distance. The security device may compare the measured distance to a same or different second distance criteria (for example, threshold 2 in FIG. 4), and when the measured distance meets the criteria (for example, equals or exceeds the threshold 2), regardless of the touch or near touch data, then the security device may transition into the Alarm Mode. Where there are more than one transition path into a same state, such as the Alarm Mode state 412, the security device may track from which state the transition was made. For example, the security device can track and differentiate transitions into the Alarm Mode state 412 from the Security Mode state 408 or the Alert Mode state 410.

At state 412, the security device is in the Alarm Mode where the security device activates one or more output indicators, such as the buzzer 126B. Depending on from which state the security device transitioned into the Alarm Mode state 412, the security device may operate its output indicators differently. For example, an Alert Mode state 410 originating notification (based on touch and distance) may use longer or louder buzzing than a Security Mode state 408 originating notification (based on distance). The security device may also send a notification to the connected host device. After a time duration of N2, which may be configured by the user, the security device may transition back into the Alert Mode state 410 or the Security Mode 408 based on the previous transition path. The Security Mode state 408, Alert Mode state 410, and the Alarm Mode state 412 can all be considered as monitoring modes. In some embodiments, the user may provide an electronic instruction via the host device to cancel the alarm (such as, if it was a false alarm), which may then transition the security device back to the Security Mode state 408.

In the modes with an established connection, such as the Operating Mode state 406, Security Mode state 408, Alert Mode state 410, or Alarm Mode state 412, if the established connection between the security device and the host device is lost, the security device transitions into the Connection Loss Mode state 414. The connection loss can be caused, for example, by low signal quality (not to be confused with weaker signal strength), interference from other devices, physical obstructions, and so forth. The loss of connection may be indicated by some output indicators on the security device or the host device. After the security device is in the Connection Loss Mode state 414, the loss of connection may be detected by the security device and/or the host device. In some embodiments the security device or the host device can provide a notification, such as providing a push notification or sounding a buzzer, about the connection loss. While in state 414, the security device waits for a time duration of N3 to re-establish the connection. A user may configure the specific time for the time duration N3. If the connection re-established within the time duration N3, the security device may transition into its previous state before the connection loss. For example, if the connection was lost while the security device was in the Operating Mode state 406 and the connection is re-established, then the security device may transition back into the Operating Mode state 406. As described before, the security device may store information on the previous state from which the device transitioned into the connection loss mode, and can revert into the previous mode. In other embodiments, if the connection is re-established within the time duration N3, then the security device may transition to Security Mode 408. If the connection does not reestablish within the time period N3, the security device may transition into the Passive Sleeping Mode state 402.

The illustrated state machine 400 is for descriptive purposes only, and it is recognized that other implementations may have more or less states than are illustrated and well as more or less user input or output indicators. For example, while the state machine diagram 400 describes controlling two LEDs, some implementations may have one or zero LEDs. Similarly, a buzzer in the state diagram 400 may be absent or replaced by a speaker. Additionally, some implementations may have shorter or longer timed durations than illustrated or described in the state machine diagram 400.

### VI. Security System Processes

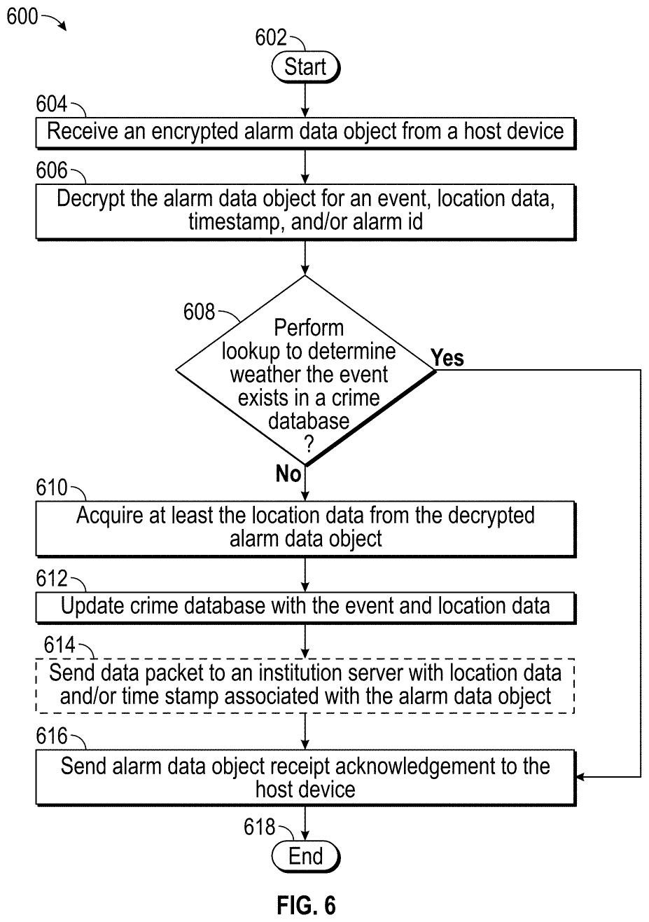

FIGS. 5 and 6 are flowcharts illustrating various embodiments of security system processes that execute within the Security Platform.

A. Security Device Process

FIG. 5 illustrates an embodiment of an example security device process 500 for detecting potential theft based on the touch detection and separation distance. In some embodiments, the security device process 500 is performed by the security application module 138 of the host device 132, and/or by one of its components. However, it is recognized that other components of the host device or other components (not shown) may perform one or more of the processes. For ease of explanation, the following describes the process as performed by the security device 102. The example scenarios are intended to illustrate, but not to limit, various aspects of the computing environment. In some embodiments, the processes can vary from the exemplary flowcharts, with some blocks omitted and other added.

At block 502, a security device is actively monitoring for theft. The active monitoring security device may be in the security mode state 408 in FIG. 4. At block 504, the security device detects, with the proximity sensor, a touch to the security device or an object in which the security device is embedded. At block 506, the security device measures the distance between the security device and the host device. If the touch has not been removed, and if the distance exceeds the distance criteria, such as a threshold value (for example, threshold 1 in FIG. 4), then the security device proceeds to block 508.

At block 508, the security device is in a state similar to the alert mode 410 in FIG. 4. The security device determines whether the touch has been removed. If the security device determines that the touch remains, then the security device loops back to block 506. Otherwise if the touch has been removed, the security device loops back to block 504. The security device proceeds to alert the host device at block 510 when both the distance criteria and the touch criteria are both met at block 506.

B. Security Server Process

FIG. 6 illustrates an embodiment of an example security server process 600 for detecting crime data triggers. In some embodiments, the security server process 600 is performed by the institution security server 204, and/or by one of its components. However, it is recognized that the institution server, other components of the security server, or other components (not shown) may perform one or more of the processes. For ease of explanation, the following describes the process as performed by the security server 204. The example scenarios are intended to illustrate, but not to limit, various aspects of the computing environment. In some embodiments, the processes can vary from the exemplary flowcharts, with some blocks omitted and other added.

At block 602, the security server waits for any incoming crime notification (see, for example, FIG. 2B). At block 604, the security server receives an alarm data object from a host device. The alarm data object may be encrypted to enhance security or to provide authenticity to the alarm data object. Various communication networks, such as Wi-Fi, cellular (3G, LTE, 5G, and so forth), radio, and so forth may carry the alarm data object from the host devices to the security servers.

At block 606, the security server decrypts the alarm data object and extracts information related to the underlying crime event associated with the alarm. Such information may include crime event information, location data, timestamp, or alarm ID. At block 608, the security server may access its crime database (for example, crime data store 220 of FIG. 2A) and perform a lookup to determine whether the same crime event already exists in the crime database. In some embodiments, the security server may execute one or more analytical or filtering algorithms to determine reliability of the alarm data object. The security server may perform extensive analysis based on past crime events and calculate a reliability score for the alarm data object. If it determines that the reliability score is too low, the security server may discard or flag the alarm data object with the reliability score. If the security server determines that a same crime event already exists in the crime database, the security server may discard the received alarm data object and proceed to block 616.

On the other hand, if the security server determines that the same crime event does not exist in the crime database, the security server proceeds to block 610 where it extracts or acquires at least the location data from the decrypted alarm data object. At block 612, the security server updates its crime database with the crime event and the location data. Optionally, at block 614, the security server may send one or more data packets to an institution server (such as a police station server) with the location data and/or timestamp associated with the alarm data object.

At block 616, the security server making knowledge the received of the alarm data object by sending an acknowledgment to the host device from which the alarm data object originated.

C. Other Processes

It is recognized that the security platform may include other processes not described above or included in the Figures. For example, in some embodiments, the security server 204 is configured to provide notifications to other host devices based on the alarm data and/or the user's criteria, such as providing a notification of a potentially stolen backpack to a parent of the user or providing a notification of a potentially stolen credit card to other authorized users of the credit card.

### VII. Example Graphical User Interfaces

In some embodiments, the security platform includes modules and instructions for providing graphical user interfaces that allow users to interact with the Security Platform via a computing device. The modules may include, but are not limited to, an application on the computing device, a cloud-based program, a remote application, or a web-based interface. Example embodiments are described as follows. FIGS. 7A-7D illustrate embodiments of example graphical user interfaces for display on a host device 134.

FIG. 7A is an embodiment of an example graphical user interface 700A for the security application module 138 that allows a user to configure and control various aspects of the security devices 102, 150, 160. The example graphical user interface 700A may provide various functionalities including connecting to a new security device 702, accessing various security application module settings 704, requesting support related to using the security application module 138 or the security devices 102, 150, 170, reporting any issues 708, acquiring general and specific guides for travelers 710, or accessing security application module information 712. Embodiments for connecting a new security device will be further described with respect to FIG. 7B. Embodiments for accessing various security application module settings will be further described with respect to FIG. 7D.

FIG. 7B is an embodiment of an example graphical user interface 700B for connecting to a new security device. The graphical interface may provide instructions 720 and a user interface element 722 for connecting an additional security device. In some implementations, a security device can be prepared for connection/pairing by pressing an input button 122 on the security device. The button input can, such as in FIG. 4, wake up the security device from its Passive Sleeping Mode state 402 into an Active Waiting Mode state 404. As described, the security device in the Active Waiting Mode state 404 may broadcast its presence and readiness for connection to nearby host devices. Then, a user may press the user interface element 722 to engage the host device to establish connection with the broadcasting security device. After the security device is connected to the host device, the user may access the security device with a graphical user interface similar to 700C in FIG. 7C.

FIG. 7C is an embodiment of an example graphical user interface 700C for display of a particular connected security device. As described, more than one security device can be simultaneously connected to a host device. The graphical user interface 700C may provide a user interface element 724 for navigating among the connected security devices and selecting a particular security device for status display, configuration, and control. The graphical user interface 700C may provide a manual refresh of the selected security device status. In some embodiments, the host device may synchronously or asynchronously interrogate the connected security device and/or update the security device status on display automatically.

The graphical user interface 700C may provide security device information, such as, for example, an identifier or name associated with each security device 730, signal strength level between the security device and the host device 738, object type associated with the security device 734 (as represented by an avatar of the security device, here, a wallet), security settings associated with the security device 736, an indicator. The host device can track the update information for each of the security devices. In some embodiments, a user may edit the ID 730 or change the object type 734 associated with the security device.

The graphical user interface 700C may also include user interface elements to configure the connected security device. For example, a user may, through the host device, interact with user interface elements (for example, icons) to configure touch detection direction 740, the proximity sensitivity level 742, alarm duration 744, or other settings 746. A user may interact with the user interface elements by tapping, dragging, pinching, providing voice commands, providing eye direction commands, and so forth. For example, tapping the touch detection direction icon 740 repeatedly may allow a user to cycle the security device to direct the touch detection direction from one direction, the other direction, and both directions. Similarly, a user may tap the proximity sensitivity level icon 742 to cycle through sensitivity levels from the most sensitive to the least sensitive. In some embodiments, touching an icon may provide to a user another graphical user interface element such that the user may provide a numeric input, a slide input, a selection input, and so forth, for the associated configurations. The host device's security application module may, after receiving user input at the host device, forward the configuration command to the security device as described with respect to the configuration communications 240 in FIG. 2B.

The graphical user interface 700C may allow a user to view event detection logs associated with the connected security device. A user may access the event log via an event log icon 748. The events may include connection, loss of connection, touch detection, change of configurations, alarm provisions, and so forth. The logged events may be stored in the security device's memory 120 and/or host device memory 140. In some embodiments, the security device may occasionally flush out its memory 120 to the host device memory 140. The graphical user interface 700C may provide a “find my device” feature. A user looking for an object may use the “find my device” feature to trigger the security device's notification including activating the buzzer 126B. When using the “find my device” feature, the host device may not notify the security server or the institution server. With the notification, a user can determine the location of the security device, thereby facilitating the search for the associated object. A user may trigger the feature by interacting with a “find my device” icon 750.

FIG. 7D is an embodiment of an example graphical user interface 700D for accessing, viewing, and configuring various settings. There may be more or less settings than the example graphical user interface 700D illustrates. Some of the settings may be associated with the host device while some of the settings may be associated with the security devices. Some settings may be associated with one or more security devices. The illustrated graphical user interface 700D includes “show scan icon” 760 for use when a host device loses connection with a connected security device. A user may customize alarm sounds 762 and lost connection sound 764. The graphical user interface 700D may provide clearing out known card associations 766. Additionally, the graphical user interface may provide one or more privacy related and/or data collection related settings 768, which the security server or the police server may collect for analysis of crime occurrence and distribution.

A. Other User Interfaces

It is recognized that the security platform may include other user interfaces not described above or included in the Figures. For example, in some embodiments, the security platform includes user interfaces to allow an administrator to perform updates on the security server 204, an administrator to create templates using the security server 204, a user to create, edit, or delete templates using the host device 134, a user to designate crime map settings using the host device 134, a user to provide data sharing provisions using the host device 134, and so forth.

### VIII. Example Crime Map

FIG. 8 illustrates an embodiment of an example crime map 800 generated from a crime database. The crime map may include a geographic map 802 and one or more filters 804. The security application module 138 can access the geographic map 802 and overlay on the map various crime related information including crime count, location, likelihood (for example, percentage), and so forth. In some embodiments, the crime map may be rendered with various color overlays to distinguish relatively safe areas from relatively dangerous areas. For example, a safe area may be formatted in green while dangerous area may be formatted in red. Additionally, some overlays may indicate city boundaries or police enforcement limits 806, and so forth.

The one or more filters 804 may include location data (for example, address, zip code, street name, city, and so forth), crime type, area filter type, crime count range, or crime event timestamp. For example, a user may request from a server, crime data associated with a known store location. The host device may provide to the server, the store name with enough geographic detail (for example, street address, zip code, town, and so forth) such that the server can identify the location of interest. In some embodiments, the host device may provide additional criteria, such as filtering only for 5 mile radius around the store, or only selecting theft and robbery. In some embodiments, the server may provide to the host device data matching the request criteria. In some embodiments, the server may provide more crime data than requested and allow the host device to filter from the accessed data according to the one or more filters 804.

In some embodiments the overlay data is provided to a third party application such that the geographic map is provided by and used in a different application, such as Google Maps or Waze.

### IX. Computing System

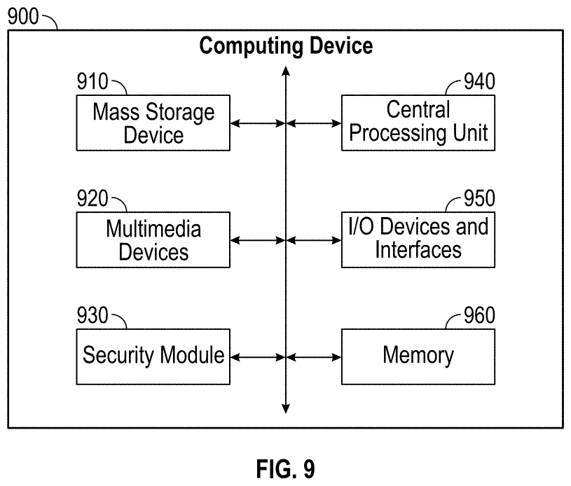

In some embodiments, any of the systems, servers, or components referenced herein may take the form of a computing system as shown in FIG. 9 which illustrates a block diagram of one embodiment of a type of computing system 900. The exemplary computing system 900 includes a central processing unit (“CPU”) 940, which may include one or more conventional microprocessors that comprise hardware circuitry configured to read computer-executable instructions and to cause portions of the hardware circuitry to perform operations specifically defined by the circuitry. The computing system 900 may also include a memory 960, such as random access memory (“RAM”) for temporary storage of information and read only memory (“ROM”) for permanent storage of information, which may store some or all of the computer-executable instructions prior to being communicated to the processor for execution. The computing system 900 may also include one or more mass storage devices 910, such as a hard drive, diskette, CD-ROM drive, a DVD-ROM drive, or optical media storage device, that may store the computer-executable instructions for relatively long periods, including, for example, when the computer system is turned off. Typically, the modules of the computing system are connected using a standard based bus system. In different embodiments, the standard based bus system could be Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of computing system may be combined into fewer components and modules or further separated into additional components and modules. The illustrated structure of the computing system 900 may also be used to implement other computing components and systems described in the disclosure. It is recognized that the components discussed herein may be implemented as different types of components. For example, a server may be implemented as a module executing on a computing device, a mainframe may be implemented on a non-mainframe server, a server or other computing device may be implemented using two or more computing devices, and/or various components could be implemented using a single computing device. Also, it is recognized that a variety of embodiments may be used and that some of the blocks in FIG. 9 may be combined, separated into sub-blocks, and rearranged to run in a different order and/or in parallel.

In one embodiment, the computing system 900 is a server, a workstation, a mainframe, or a minicomputer. In other embodiments, the system may be a personal computer that is IBM, Macintosh, or Linux/Unix compatible, a laptop computer, a tablet, a handheld device, a mobile phone, a smart phone, a smart watch, a wearable device, a personal digital assistant, a car system, a tablet or other user device. Servers may include a variety of servers such as database servers (for example, Oracle, DB2, Informix, Microsoft SQL Server, MySQL, or Ingres), application servers, data loader servers, or web servers. In addition, the servers may run a variety of software for data visualization, distributed file systems, distributed processing, web portals, enterprise workflow, form management, and so forth.

The computing system 900 may be generally controlled and coordinated by operating system software, such as Windows 95, Windows 98, Windows NT, Windows 2000, Windows XP, Windows Vista, Windows 7, Windows 8, Windows 10, Unix, Linux, SunOS, Solaris, Maemo, MeeGo, BlackBerry Tablet OS, Android, webOS, Sugar, Symbian OS, MAC OS X, or iOS or other operating systems. In other embodiments, the computing system 900 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 900 includes one or more commonly available input/output (“I/O”) devices and interfaces 950, such as a keyboard, mouse, touchpad, speaker, microphone, or printer. In one embodiment, the I/O devices and interfaces 950 include one or more display device, such as a touchscreen, display or monitor, which allows the visual presentation of data to a user. More particularly, a display device provides for the presentation of GUls, application software data, and multimedia presentations, for example. The central processing unit 940 may be in communication with a display device that is configured to perform some of the functions defined by the computer-executable instructions. For example, some of the computer-executable instructions may define the operation of displaying to a display device, an image that is like one of the user interfaces included in this application. The computing system 900 may also include one or more multimedia devices 920, such as speakers, video cards, graphics accelerators, and microphones, for example. A skilled artisan would appreciate that, in light of this disclosure, a system, including all hardware components, such as the central processing unit 940, I/O devices 950, memory 960, and mass storage device 910 that are necessary to perform the operations illustrated in this application, is within the scope of the disclosure.

In the embodiment of FIG. 9, the I/O devices and interfaces provide a communication interface to various external devices and systems. The computing system may be electronically coupled to a network, which comprises one or more of a LAN, WAN, the Internet, or cloud computing networks, for example, via a wired, wireless, or combination of wired and wireless, communication links. The network communicates with various systems or other systems via wired or wireless communication links, as well as various data sources.

Information may be provided to the computing system 900 over the network from one or more data sources including, for example, the host device 134, the security devices 102A, 150, 160, the security server 204, the crime data store 208, the institution server 213, and so forth. In addition, the network may communicate with other data sources or other computing devices such as a third party survey provider system or database, for example. The data sources may include one or more internal or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, a noSQL database, an object-oriented database, or a record-based database.

In the embodiment of FIG. 9, the computing system 900 also includes a security module 930 which may be executed by the CPU 940, to run one or more of the processes discussed herein. This system may include, by way of example, components, such as software components, object-oriented software components, class components, task components, processes, functions, attributes, procedures, subroutines, segments of program code, drivers, firmware, microcode, circuitry, data, databases, data structures, tables, arrays, or variables.

Embodiments can be implemented such that all functions illustrated herein are performed on a single device, while other embodiments can be implemented in a distributed environment in which the functions are collectively performed on two or more devices that are in communication with each other. Moreover, while the computing system 900 has been used to describe one embodiment of components used in a security platform, it is recognized that the user systems may be implemented as computing systems as well.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, or may be invoked in response to detected events or interrupts. Software instructions may be embedded in firmware, such as an EPROM. It will be further appreciated that hardware modules may be comprised of connected logic units, such as gates and flip-flops, or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

It is recognized that the term “remote” may include systems, data, objects, devices, components, or modules not stored locally, that are not accessible via the local bus. Thus, remote data may include a system that is physically stored in the same room and connected to the computing system via a network. In other situations, a remote device may also be located in a separate geographic area, such as, for example, in a different location, country, and so forth.

### X. Additional Embodiments

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Depending on the embodiment, certain acts, events, or functions of any of the processes or algorithms described herein can be performed in a different sequence, can be added, merged, or left out altogether (for example, not all described operations or events are necessary for the practice of the algorithm). Moreover, in certain embodiments, operations or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure. The code modules may be stored in any type of non-transitory computer-readable medium or other computer storage device. Some or all the methods may alternatively be embodied in specialized computer hardware.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Language of example or capability used herein, such as, among others, “can,” “could,” “might,” “may,” “for example,” “some,” “certain,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, and so forth, may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown and described features as applied to various example embodiments, omissions, substitutions, additions, and changes in the form and details of the devices or algorithms described can be made without departing from the spirit of the disclosure. All such modifications and variations are intended to be included herein within the scope of this disclosure and protected by the following. Certain embodiments described herein can be embodied within a form that does not provide all of the features and benefits set forth herein, as some features can be used or practiced separately from others.

What is claimed:

1. A security alarm device associated with a protected object, the security alarm device comprising:
one or more hardware processors;
one or more output components;
a proximity sensor in electronic communication with the one or more hardware processors and configured to provide to the one or more hardware processors a touch data signal indicative of a touch or near touch to a protected object;
a communication component in electronic communication with the one or more hardware processors and configured to provide to the one or more hardware processors a distance data signal indicative of a distance between the communication component and a host computing device; and
one or more storage devices configured to store software instructions configured for execution by the one or more hardware processors, wherein the software instructions cause the one or more hardware processors to:
receive, from the proximity sensor, the touch data signal indicative of the touch to the protected object or the security alarm device;
receive, from the communication component, the distance data signal indicative of a distance;
based at least in part on the touch data signal and the distance data signal, determine that one or more notification criteria have been met: and
in response to determining the one or more notification criteria have been met, generate a notification data signal to one or more output components to provide a notification.

2. The security alarm device according to claim 1, wherein the proximity sensor is a capacitance proximity sensor.

3. The security alarm device according to claim 2 further comprising a proximity sensor sensitivity selection component configured to adjust, based on the proximity sensor sensitivity selected, a proximity sensitivity.

4. The security alarm device according to claim 3, wherein the proximity sensitivity comprises a plurality of predetermined sensitivity levels.

5. The security alarm device according to claim 2 the one or more output components comprising a buzzer, a piezoelectric buzzer, an actuator, or a light emitting diode.

6. The security alarm device according to claim 1, wherein the software instructions further cause the one or more hardware processors to generate a crime event data packet to be sent via the host device to a security server for inclusion in a crime map data set, the crime event data packet including a date indication, a time indication, a location indication, an object indication, and an event indication.

7. The security alarm device according to claim 1, wherein a distance evaluation criteria of the one or more criteria comprise a threshold distance, and the software instructions further cause the one or more hardware processors to compare the threshold distance with the distance data signal to determine a total distance such that the distance evaluation criteria is met if the total distance is equal to or exceeds the threshold distance.

8. The security alarm device according to claim 1, wherein the distance data signal comprises an indication of a signal strength between the protected object and the host computing device.

9. The security alarm device according to claim 1, wherein a touch evaluation criteria of the one or more criteria comprise a touch indicator, and the software instructions further cause the one or more hardware processors to analyze the touch data signal to determine whether the touch evaluation criteria has been met.

10. The security alarm device according to claim 9, wherein the software instructions further cause the one or more hardware processors to evaluate the touch evaluation criteria and, to evaluate the distance evaluation criteria if the touch evaluation criteria has been met.

11. The security alarm device according to claim 1, wherein the security alarm device is configured to electronically communicate, via the communication component, with the host computing device and the host computing device is a mobile device including one or more of: a smart phone, tablet PC, laptop, or a wearable device.

12. A computer-implemented method of detecting a potential security breach, the computer-implemented method comprising:
as implemented by one or more computing devices within a security alarm device configured with specific computer-executable instructions,
receiving, from a proximity sensor within the security alarm device, a touch data signal indicative of a touch to a protected object or a security alarm device;
receiving, from a communication component within the security alarm device, a distance data signal indicative of a distance between the communication component and a host computing device;
based at least in part on the touch data signal and the distance data signal, determining that one or more notification criteria have been met; and
in response to determining that the one or more notification criteria have been met, generating a notification data signal to one or more output components within the security alarm device to provide a potential security breach notification, where in the output component comprise one or more of a buzzer, a piezoelectric buzzer, an actuator, or a light emitting diode.

13. The computer-implemented method of claim 12, wherein the proximity sensor is a capacitance proximity sensor.

14. The computer-implemented method of claim 12, further generating a crime event data packet to be sent via the host device to a security server for inclusion in a crime map data set, the crime event data packet including a date indication, a time indication, a location indication, an object indication, and an event indication.

15. The computer-implemented method of claim 12, wherein a distance evaluation criteria of the one or more criteria comprise, and the specific computer-executable instructions further cause the one or more computing devices to compare a threshold distance with the distance data signal to determine a total distance such that the distance evaluation criteria is met if the total distance is equal to or exceeds the threshold distance.

16. The computer-implemented method of claim 12, wherein a touch evaluation criteria of the one or more criteria comprise a touch indicator, and the specific computer-executable instructions further cause the one or more computing devices to analyze the touch data signal to determine whether the touch evaluation criteria has been met.

17. The computer-implemented method of claim 12, wherein the distance data signal comprises an indication of a signal strength between the protected object and the host computing device.

18. Non-transitory computer storage having stored thereon a computer program, the computer program including executable instructions that instruct a computer system to at least:
receive, from a proximity sensor within a security alarm device, a touch data signal indicative of a touch to a protected object or a security alarm device;
receive, from a communication component within the security alarm device, a distance data signal indicative of a distance between the communication component and a host computing device;
based at least in part on the touch data signal and the distance data signal, determine that one or more notification criteria have been met; and
in response to determining that the one or more notification criteria have been met, generate a notification data signal to one or more output components within the security alarm device to provide a potential security breach notification, where in the output component comprise one or more of a buzzer, a piezoelectric buzzer, an actuator, or a light emitting diode.

19. The non-transitory computer storage of claim 18, the executable instructions further comprising:
generate a crime event data packet to be sent via the host device to a security server for inclusion in a crime map data set, the crime event data packet including a date indication, a time indication, a location indication, an object indication, and an event indication

20. The non-transitory computer storage of claim 18, the executable instructions further comprising:
comparing a threshold distance with the distance data signal to determine a total distance such that a distance evaluation criteria is met if the total distance is equal to or exceeds the threshold distance.
